(19) United States
(12) Patent Application Publication
(10) Pub. No.: US 2025/0274068 A1
(43) Pub. Date: Aug. 28, 2025

(54) ABNORMALITY DETERMINATION DEVICE

(71) Applicant: TOYOTA JIDOSHA KABUSHIKI KAISHA, Toyota-shi (JP)

(72) Inventor: Tomokazu YAMAUCHI, Akazaki-shi (JP)

(73) Assignee: TOYOTA JIDOSHA KABUSHIKI KAISHA, Toyota-shi (JP)

(21) Appl. No.: 18/966,166

(22) Filed: Dec. 3, 2024

(30) Foreign Application Priority Data
Feb. 28, 2024 (JP) 2024-028121

(51) Int. Cl. H02P 29/024; H02K 11/25

(52) U.S. Cl. CPC H02P 29/024; H02K 11/25

(57) ABSTRACT

A multi-phase alternating current motor, an inverter for driving a multi-phase alternating current motor, a plurality of wires connecting the coil and the inverter of each phase of the motor, an abnormality determination device for determining an abnormality of the connection between the inverter and the plurality of wires, provided for each wire, a plurality of temperature sensors for detecting the temperature at a position where the influence of the temperature of the connection portion of the wiring to the inverter is reduced, the abnormality of the motor device based on the variation in temperature detected by the plurality of temperature sensors.

### CROSS-REFERENCE TO RELATED APPLICATION

This application claims priority to Japanese Patent Application No. 2024-028121 filed on Feb. 28, 2024, incorporated herein by reference in its entirety.

### BACKGROUND

### 1. Technical Field

The present disclosure relates to an abnormality determination device.

### 2. Description of Related Art

Conventionally, an abnormality determination device has been proposed as an abnormality determination device of this type, the abnormality determination device being used in a motor device that includes a three-phase alternating current motor and an inverter, and includes three current sensors (for example, refer to Japanese Unexamined Patent Application Publication No. 2009-131043 (JP 2009-131043 A)). The inverter drives the three-phase alternating current motor. The three current sensors detect a current of each phase of the three-phase alternating current motor. In the abnormality determination device, when the sum of phase currents detected by the three current sensors is larger than a predetermined value, the abnormality determination device determines that an abnormality has occurred in one of the three current sensors.

### SUMMARY

However, in the abnormality determination device, an abnormality of a connection portion between the inverter and wires that connect the inverter and a coil of each phase of the three-phase alternating current motor is not determined. As a technique that determines an abnormality of the connection portion, it is conceivable to determine an abnormality based on the sum of the phase currents detected by the three current sensors. However, in the technique, since the phase current that is a detection target is an alternating current, it is difficult to accurately detect an instantaneous current value. Therefore, the sum of the phase currents is not able to be accurately calculated, and an abnormality is not able to be accurately determined.

An abnormality determination device of the present disclosure has a main objective to determine an abnormality of a connection portion with more accuracy.

The abnormality determination device of the present disclosure adopts the following technique to achieve the main objective.

An abnormality determination device of the present disclosure is used in a motor device and determines an abnormality in the motor device, the abnormality determination device including
a multi-phase alternating current motor,
an inverter that drives the multi-phase alternating current motor, and
a plurality of wires that connects the inverter and a coil of each phase of the multi-phase alternating current motor, in which
the abnormality determination device includes a plurality of temperature sensors provided for each of the wires, the temperature sensors each being configured to detect a temperature at a position at which an influence of a temperature of a connection portion between the inverter and each of the wires is reduced, and
the abnormality determination device is configured to determine an abnormality of the motor device based on a variation in a temperature detected by each of the temperature sensors.

In the abnormality determination device of the present disclosure, a plurality of temperature sensors are provided for each of the wires, the temperature sensors each being configured to detect the temperature at a position at which an influence of the temperature of a connection portion between the inverter and the wire is reduced. Also, an abnormality of the connection portion is determined based on a variation in the temperature detected by the temperature sensor. When an abnormality such as a contact failure occurs in the connection portion, a variation in current between each of the wires increases, and a variation in the temperature between the wires increases. Therefore, an abnormality of the connection portion can be determined based on a variation in the temperature detected by the temperature sensor. Since each of the temperature sensors detects the temperature at a position at which an influence of the temperature of the connection portion between the inverter and the wire is reduced, the influence of the temperature of the connection portion on a detection value of the temperature sensor can be reduced. As a result, an abnormality of the connection portion can be determined more accurately.

The abnormality determination device of the present disclosure may be configured to
calculate a temperature deviation between the wires based on a temperature detected by each of the temperature sensors, and when the temperature deviation is equal to or more than a threshold, the abnormality determination device may be configured to determine that an abnormality has occurred in the connection portion between the inverter and a wire to which a temperature sensor that detects a lower temperature among two temperatures used when calculating the temperature deviation is connected.
   When an abnormality occurs in which the resistance of the connection portion increases, such as a contact failure, at the connection portion between the inverter and the wire, the current (effective value) of the wire reduces, and an increase in the temperature is suppressed. On the other hand, the current (effective value) of the other wires increases and the temperature rises. Therefore, the temperature deviation between the wire in which an abnormality occurs in the connection portion and the normal wires increases. Accordingly, when the temperature deviation is equal to or more than a threshold, the abnormality determination device determines that an abnormality has occurred in the connection portion between the inverter and the wire to which the temperature sensor that detects a lower temperature among two temperatures used when calculating the temperature deviation is connected. As a result, an abnormality of the connection portion can be determined more accurately.

Moreover in the abnormality determination device of the present disclosure, the temperature deviation may be calculated by using a corrected temperature obtained by correcting a temperature detected by each of the temperature sensors with an ambient temperature in a periphery of the temperature sensor.

As a result, the temperature deviation can be calculated more accurately, regardless of the ambient temperature in the periphery of the temperature sensor. As a result, an abnormality of the connection portion can be determined more accurately.

In addition, in the abnormality determination device of the present disclosure,
the position at which an influence of a temperature of the connection portion between the inverter and each of the wires is reduced may be a center portion of each of the wires.
   Therefore, since the abnormality determination device can determine an abnormality of the connection portion based on the temperature of the wire detected more appropriately, an abnormality of the connection portion can be determined more accurately.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a configuration of a motor device 20 according to an embodiment of the present disclosure;

FIG. 2 is a schematic arrangement of the motor 22 and the inverter 30 in the engine compartment of the vehicle as viewed from the front of the vehicle; and

FIG. 3 is a flow chart illustrating an exemplary determination routine executed by ECU 50.

### DETAILED DESCRIPTION OF EMBODIMENTS

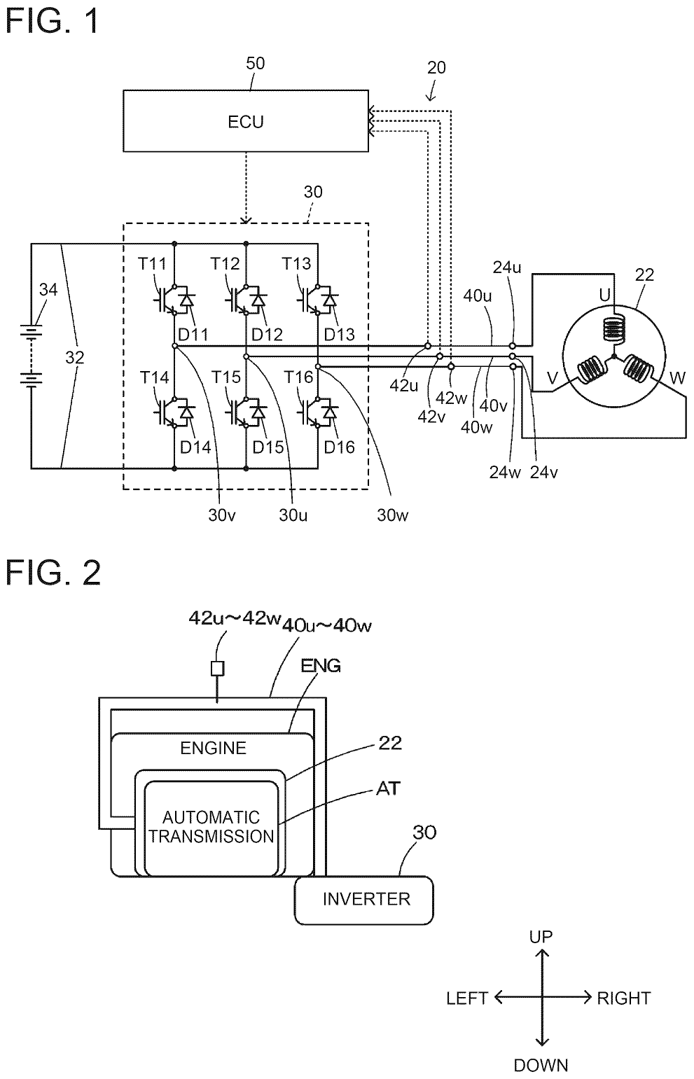

Embodiments of the present disclosure will be described with reference to the drawings. FIG. 1 is a configuration diagram schematically showing a configuration of a motor device 20 according to an embodiment of the present disclosure. FIG. 2 is a schematic arrangement diagram showing the arrangement of the motor 22 and the inverter 30 in the engine compartment of the vehicle as viewed from the front of the vehicle.

As illustrated in FIG. 1, the motor device 20 includes a motor 22, an inverter 30 that drives the motor 22, a cable 40u, 40v, 40w as a wire, a battery 34, and an electronic control unit (hereinafter, referred to as “ECU”) 50. The battery 34 is connected to the inverter 30 via a power line 32. As shown in FIG. 2, the motor device 20 is mounted in an engine compartment of vehicles together with an engine ENG and an automatic transmission AT. In the engine compartment, the automatic transmission AT, the motor 22, and the engine ENG are arranged in this order from the front. Inverters 30 are located below the right side of FIG. 2 of the engine ENG.

The motor 22 is configured as a known three-phase alternating current rotating electric machine. Each of the phase coils U, V, and W of the motor 22 is connected to a corresponding connection terminal 24u, 24v, 24w.

Inverter 30 is connected to power line 32. Inverter 30 has six transistors T11 to T16 and six diodes D11 to D16. T16 from the transistor T11, with respect to the positive and negative bus of the power line 32, respectively, so that the source side and the sink side, are arranged in pairs by two. The six diodes D11 to D16 are each connected in anti-parallel from transistor T11 to T16. A connection point between transistors that are pairs of transistors T11 to T16 is connected to a connection terminal 30u, 30v, 30w.

Cable 40u, 40v, 40w are well known cables constructed by coating conductors with insulators. The cable 40u, 40v, 40w is connected to the connection terminal 24u, 24v, 24w of the motor 22 and the connection terminal 30u, 30v, 30w of the inverter 30 by a connector (not shown). As shown in FIG. 2, when viewed from the front of the vehicle, the cable 40u, 40v, 40w extends leftward from the motor 22 in a bundled manner. Thereafter, the cable 40u, 40v, 40w is bent upward at a substantially right angle and extends rightward at a substantially right angle, and is bent downward at a substantially right angle to be connected to the inverter 30. The cable 40u, 40v, 40w is arranged in this way.

Although not shown, ECU 50 is configured as a microprocessor centered on CPU. In addition to CPU, ECU 50 includes a ROM for storing a process program, a RAM for temporarily storing data, a flash memory for storing and holding data, an input/output port, and a communication port. A cable temperature Tcu, Tcv, Tcw from a temperature sensor 42u, 42v, 42w attached to an intermediate portion of the cable 40u, 40v, 40w is inputted to ECU 50. A switching control signal to the inverter 30 is outputted from ECU 50. The temperature sensor 42u, 42v, 42w is attached to an intermediate portion of the cable 40u, 40v, 40w. The reason for this is to reduce the effect of the temperature of the connection portion of the cable 40u, 40v, 40w with the connection terminal 30u, 30v, 30w of the inverter on the detected value of the temperature sensor 42u, 42v, 42w. Attach the temperature sensor 42u, 42v, 42w to the middle of the cable 40u, 40v, 40w. Accordingly, it is possible to suppress the cable temperature Tcu, Tcv, Tcw from being affected by the temperature of the connection portion of the cable 40u, 40v, 40w with the connection terminal 30u, 30v, 30w of the inverter 30.

In the motor device 20 configured as described above, the ratio of the on-time of T16 from the pair of transistors T11 is adjusted when a voltage is applied to the inverter 30. As a result, a rotating magnetic field is formed in the stator of the motor 22, and the motor 22 is rotationally driven.

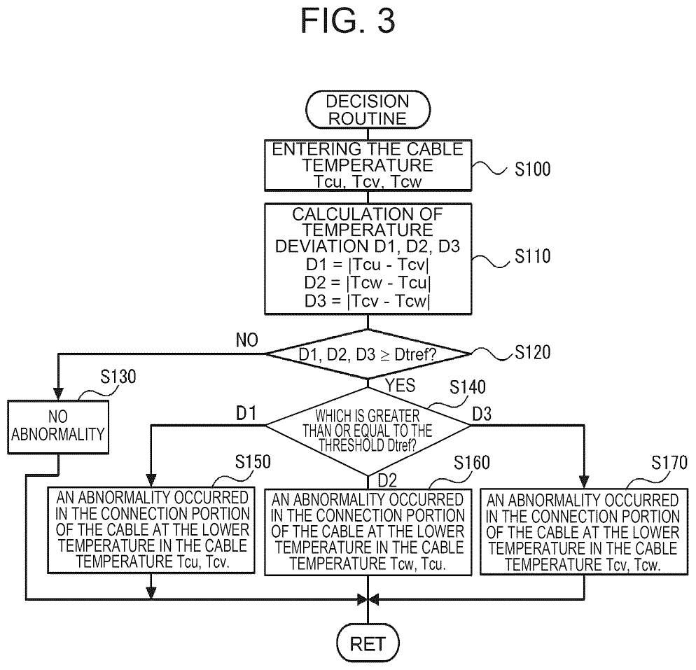

Next, the operation of the motor device 20 configured in this way, in particular, the operation when determining the abnormality will be described. FIG. 3 is a flow chart illustrating an exemplary determination routine executed by ECU 50. This routine is repeatedly executed during the driving of the motor device 20.

When the routine is executed, ECU 50 receives the cable temperature Tcu, Tcv, Tcw from the temperature sensor 42u, 42v, 42w (S100). Then, the temperature deviation D1, D2, D3 between the cable temperature Tcu, Tev, Tcw is calculated using the following equations (1) to (3) (S110).

$$D 1 = \vert Tcu - Tcv \vert \qquad ( 1 )$$

$$D 2 = \vert Tcw - Tcu \vert \qquad ( 2 )$$

$$D 3 = \vert Tcv - Tcw \vert \qquad ( 3 )$$

Next, it is determined whether or not the temperature deviation D1, D2, D3 is equal to or greater than the threshold Dtref (S120). The threshold Dtref is a threshold for determining whether or not a variation has occurred in the cable-temperature Tcu, Tcv, Tcw. When the connection between each cable and the corresponding connection terminal is good, the current flowing through each cable (execution value) is about the same, the variation in temperature between the cables is small. Consider a case where an abnormality such as a connection failure between a cable and a connection terminal occurs, such as a looseness of a connector connecting each cable and a corresponding connection terminal. In this case, the resistance of the connection portion in which the abnormality has occurred increases, and the current (effective value) flowing through the cable connected to the connection portion in which the abnormality has occurred decreases. On the other hand, the current (effective value) of the other cable increases. Therefore, when an abnormality occurs in the connection portion, the variation of the current (effective value) between the cables increases, and the variation of the cable temperature Tcu, Tcv, Tcw detected by the temperature sensor 42u, 42v, 42w increases. Therefore, it is possible to determine whether or not an abnormality has occurred in the connection portion by examining the temperature deviation D1, D2, D3 of the cable temperature Tcu, Tcv, Tcw.

When all of the temperature deviation D1, D2, D3 are less than the threshold Dtref in S120, it is determined that an abnormality has not occurred (S130), and the routine ends.

In S120, when any of the temperature deviation D1, D2, D3 is equal to or larger than the threshold Dtref, the temperature deviation that becomes equal to or larger than the threshold Dtref among the temperature deviation D1, D2, D3 is determined (S140). When the temperature deviation D1 is equal to or higher than the threshold Dtref in the temperature deviation D1, D2, D3, the following determination is performed. That is, it is determined that an abnormality has occurred in the connection portion between the cable to which the temperature sensor that detects the lower temperature among the cable temperature Tcu, Tcv used in calculating the temperature deviation D1 is connected, and the inverter (S150). Then, the routine ends. When the temperature deviation D2 is equal to or higher than the threshold Dtref in the temperature deviation D1, D2, D3, the following determination is performed. That is, it is determined that an abnormality has occurred in the connection portion between the cable to which the temperature sensor that detects the lower temperature among the cable temperature Tcw, Tcu used in calculating the temperature deviation D2 is connected, and the inverter (S160). Then, the routine ends. When the temperature deviation D3 is equal to or higher than the threshold Dtref in the temperature deviation D1, D2, D3, the following determination is performed. That is, it is determined that an abnormality has occurred in the connection portion between the cable to which the temperature sensor that detects the lower cable temperature among the cable temperature Tcv, Tcw used in calculating the temperature deviation D3 is connected, and the inverter (S170). Then, the routine ends. As described above, when any one of the temperature deviation D1, D2, D3 is equal to or larger than the threshold Dtref, the following determination is performed. That is, it is determined that an abnormality has occurred in the connection portion between the cable to which the temperature sensor that detects the lower cable temperature among the two cable temperatures is connected and the inverter. The two cable temperatures are cable temperatures used in calculating a temperature deviation that is equal to or higher than the threshold Dtref of the temperature deviation D1, D2, D3. As a result, an abnormality of the connection portion can be determined more accurately. That is, the abnormality of the connection portion can be determined more accurately by determining the abnormality of the motor device 20 based on the variation in the cable temperature Tcv, Tcu, Tcw.

According to the motor device 20 of the present embodiment described above, the abnormality of the motor device 20 can be determined more accurately by determining the abnormality of the motor device 20 based on the variation in the cable temperature Tcv, Tcu, Tcw.

When any of the temperature deviation D1, D2, D3 is greater than or equal to the threshold Dtref, the following determination is performed. That is, it is determined that an abnormality has occurred in the connection portion between the cable to which the temperature sensor that detects the lower cable temperature among the two cable temperatures is connected and the inverter. The two cable temperatures are cable temperatures used in calculating a temperature deviation that is equal to or higher than the threshold Dtref of the temperature deviation D1, D2, D3. As a result, an abnormality of the connection portion can be determined more accurately.

In the above-described embodiment, the temperature deviation D1, D2, D3 between the cable temperature Tcu, Tev, Tcw is calculated by the above-described equations (1) to (3). However, consider that the temperature of the cable 40u, 40v, 40w is affected by the ambient temperature around the temperature sensor 42u, 42v, 42w, such as the exhaust heat of the engine ENG or electronic components. In this case, the temperature of the cable 40u, 40v, 40w may not accurately reflect the current flowing through the cable 40u, 40v, 40w. Therefore, an ambient temperature sensor for detecting the ambient temperature is further provided around the temperature sensor 42u, 42v, 42w. Then, the cable temperature Tcu, Tcv, Tcw is corrected by the ambient temperature Tau, Tav, Taw around the temperature sensor 42u, 42v, 42w. Then, the temperature deviation D1, D2, D3 may be calculated by the following equations (4) to (6) using the obtained corrected temperature Tcuc, Tcvc, Tcwc. The calculation method of the corrected temperature Tcuc, Tevc, Tcwc is various. For example, the corrected temperature Tcuc may be calculated by subtracting the ambient temperature Tau from the cable temperature Tcu. The corrected temperature Tcvc, Tcwc may be calculated by subtracting the ambient temperature Tau from the cable temperature Tcu, Tcv, Tcw as in the corrected temperature Tcuc.

$$D 1 = \vert Tcuc - Tcvc \vert \qquad ( 4 )$$

$$D 2 = \vert Tcwc - Tcuc \vert \qquad ( 5 )$$

$$D 3 = \vert Tcvc - Tcwc \vert \qquad ( 6 )$$

In the above-described embodiment, the temperature deviation D1, D2, D3 between the cable temperature Tcu, Tcv, Tcw is calculated by the above-described equations (1) to (3). However, the abnormality of the motor device 20 may be determined using other indices that reflect variations in the cable temperature Tcu, Tcv, Tcw instead of the temperature deviation D1, D2, D3. For example, an abnormality of the motor device 20 may be determined when the lowest temperature of the cable temperature Tcu, Tcv, Tcw is less than the threshold Tref. The threshold Tref may be a threshold value for determining whether or not the current (effective value) flowing through the cable is small due to an abnormality in the connection portion.

In the above-described embodiment, the temperature sensor 42u, 42v, 42w is disposed in a center portion of the cable 40u, 40v, 40w. However, the temperature sensor 42u, 42v, 42w may detect the temperature at a position where the effect of the temperature of the connection portion with the inverter 30 in the cable 40u, 40v, 40w is reduced. Therefore, the temperature sensor 42u, 42v, 42w does not necessarily have to be attached to the intermediate portion. For example, the temperature sensor 42u, 42v, 42w may detect a temperature closer to the motor 22 than the intermediate portion.

In the above-described embodiment, the present disclosure is applied to a motor device 20 including a motor 22 configured as a three-phase alternating current rotating electric machine. However, the present disclosure may be applied to a motor configured as a two-phase alternating current rotating electric machine and a motor configured as a four-phase or higher-phase alternating current rotating electric machine.

The correspondence between the main elements of the embodiments and the main elements of the disclosure described in the column of the means for solving the problem will be described. In the embodiment, the motor 22 is an example of a “multi-phase alternating current motor”, the inverter 30 is an example of an “inverter”, the cable 40u, 40v, 40w is an example of a “plurality of cables”, the motor device 20 is an example of a “motor device”, and ECU 50 is an example of an “abnormality determination device”.

The correspondence between the main elements of the embodiment and the main elements of the disclosure described in the section of the means for solving the problem is an example for specifically explaining the embodiment of the disclosure described in the section of the means for solving the problem. Therefore, these are not intended to limit the elements of the disclosure described in the section of Means for solving the problem. That is, the interpretation of the disclosure described in the section of the means for solving the problem should be performed based on the description in the section, and the embodiments are only specific examples of the disclosure described in the section of the means for solving the problem.

Hereinafter, while embodiments for carrying out the present disclosure are described by using embodiments, it is needless to say that the present disclosure is not limited to such embodiments, and can be implemented in various forms without departing from the gist of the present disclosure.

The present disclosure is applicable to a manufacturing industry of an abnormality determination apparatus and the like.

What is claimed is:

1. An abnormality determination device used in a motor device and that determines an abnormality in the motor device, the abnormality determination device comprising:
a multi-phase alternating current motor;
an inverter that drives the multi-phase alternating current motor, and
a plurality of wires that connects the inverter and a coil of each phase of the multi-phase alternating current motor, wherein
the abnormality determination device includes a plurality of temperature sensors provided for each of the wires, the temperature sensors each being configured to detect a temperature at a position at which an influence of a temperature of a connection portion between the inverter and each of the wires is reduced, and
the abnormality determination device is configured to determine an abnormality of the motor device based on a variation in a temperature detected by each of the temperature sensors.

2. The abnormality determination device according to claim 1, wherein the abnormality determination device is configured to calculate a temperature deviation between the wires based on a temperature detected by each of the temperature sensors, and when the temperature deviation is equal to or more than a threshold, the abnormality determination device is configured to determine that an abnormality has occurred in the connection portion between the inverter and a wire to which a temperature sensor that detects a lower temperature among two temperatures used when calculating the temperature deviation is connected.

3. The abnormality determination device according to claim 2, wherein the temperature deviation is calculated by using a corrected temperature obtained by correcting a temperature detected by each of the temperature sensors with an ambient temperature in a periphery of the temperature sensor.

4. The abnormality determination device according to claim 1, wherein the position at which an influence of a temperature of the connection portion between the inverter and each of the wires is reduced is a center portion of each of the wires.
